(19) United States
(12) Patent Application Publication
(10) Pub. No.: US 2026/0245895 A1
(43) Pub. Date: Aug. 20, 2026

(54) LITHIUM SECONDARY BATTERY

(71) Applicant: SK ON CO., LTD., Seoul (KR)

(72) Inventors: Min Suk KANG, Daejeon (KR); Ji Yae DO, Daejeon (KR); Min Cheol BAEK, Daejeon (KR); Sang Wook LEE, Daejeon (KR); Yong Hyun CHO, Daejeon (KR)

(21) Appl. No.: 19/162,378

(22) PCT Filed: Feb. 15, 2024
(86) PCT No.: PCT/KR2024/002114

§ 371 Date: Sep. 4, 2025

(30) Foreign Application Priority Data
Mar. 10, 2023 (KR) 10-2023-0031775

(51) Int. Cl. H01M 4/58; H01M 4/587; H01M 10/0525

(52) U.S. Cl. CPC H01M 4/5825; H01M 4/587; H01M 10/0525

(57) ABSTRACT

Embodiments of the present disclosure provide a lithium secondary battery. A lithium secondary battery according to exemplary embodiments includes a cathode including a cathode active material including first cathode active material particles and second cathode active material particles that are different from the first cathode active material particles and are represented by Formula 2, and an anode disposed to face the cathode and including an anode active material including a silicon-based active material.

### TECHNICAL FIELD

The disclosure of the present application relates to a lithium secondary battery.

### BACKGROUND ART

Secondary batteries are batteries that can be repeatedly charged and discharged.

With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric cars.

Examples of the secondary battery may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design. In this regard, the lithium secondary battery has been actively developed and applied to various industrial fields.

The cathode active material of a lithium secondary battery may include a lithium metal phosphate. The anode active material of a lithium secondary battery may include a silicon-based active material.

Due to a difference in the charge-discharge efficiency between the cathode active material and the anode active material, the energy density of the lithium secondary battery may be reduced.

### SUMMARY OF INVENTION

### Problems to be Solved by Invention

An object of the present disclosure is to provide a lithium secondary battery with improved energy density.

### Means for Solving Problems

A lithium secondary battery according to exemplary embodiments of the present disclosure includes: a cathode including a cathode active material including first cathode active material particles and second cathode active material particles that are different from the first cathode active material particles and are represented by Formula 2 below; and an anode disposed to face the cathode and including an anode active material including a silicon-based active material.

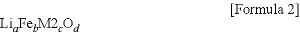

In Formula 2, 4.5≤a≤5.5, 0.99≤b≤1.01, 0≤c≤1, 3.9≤d≤4.1, and M2 includes at least one selected from the group consisting of Mn, Ti and V.

In some embodiments, the first cathode active material particles may include lithium metal phosphate particles represented by Formula 1 below.

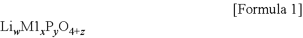

In Formula 1, 0.9≤w≤1.2, 0.99≤x≤1.01, 0.9≤y≤1.2, −0.1≤z≤0.1, and M1 includes at least one selected from the group consisting of Fe, Co, Ni, Mn, Ti and V.

In some embodiments, the first cathode active material particles may include LiFePO₄.

In some embodiments, the second cathode active material particles may include Li₅FeO₄.

In some embodiments, the content of the second cathode active material particles, based on the total weight of the cathode active material, may be 5% by weight to 12% by weight.

In some embodiments, the silicon-based active material may include SiOₓ (0<x<2).

In some embodiments, the anode active material may further include a graphite-based active material.

In some embodiments, the graphite-based active material may include at least one selected from the group consisting of artificial graphite and natural graphite.

In some embodiments, the content of the silicon-based active material, based on the total weight of the anode active material, may be 5% by weight to 20% by weight.

In some embodiments, the silicon-based active material may include a carbon coating disposed on an outermost portion thereof.

In some embodiments, an average composition of the entire cathode active material may be expressed by Formula 3 below.

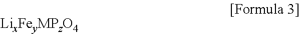

In Formula 3, 1.02≤x≤1.56, 0.99≤y≤1.01, 0.86≤z≤0.995, and M includes at least one selected from the group consisting of Mn, Ti and V.

In some embodiments, the first cathode active material particles and the second cathode active material particles may each further include an auxiliary element included in a layered structure, and the auxiliary element may include at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra and P.

### Advantageous Effects

In exemplary embodiments, the irreversible capacity of the lithium secondary battery may be reduced, thereby enhancing energy density.

In exemplary embodiments, the capacity characteristics of the anode active material may be enhanced.

The lithium secondary battery of the present disclosure may be widely applied in green technology fields, such as electric vehicles, battery charging stations, as well as solar power generation, wind power generation, and the like, which use the batteries. The lithium secondary battery of the present disclosure may be used in eco-friendly electric vehicles, hybrid vehicles, and the like, which are aimed at mitigating climate change by reducing air pollution and greenhouse gas emissions.

### BRIEF DESCRIPTION OF DRAWINGS

FIGS. 1 and 2 are schematic plan and cross-sectional views, respectively, illustrating a lithium secondary battery according to exemplary embodiments.

### MODE FOR CARRYING OUT INVENTION

Embodiments of the present disclosure provide a lithium secondary battery including a cathode and an anode.

Hereinafter, embodiments of the present disclosure will be described in detail with reference to the drawings. However, the embodiments are merely illustrative, and the present disclosure is not limited to the specific embodiments described as examples.

In exemplary embodiments, the lithium secondary battery includes a cathode and an anode disposed to face the cathode.

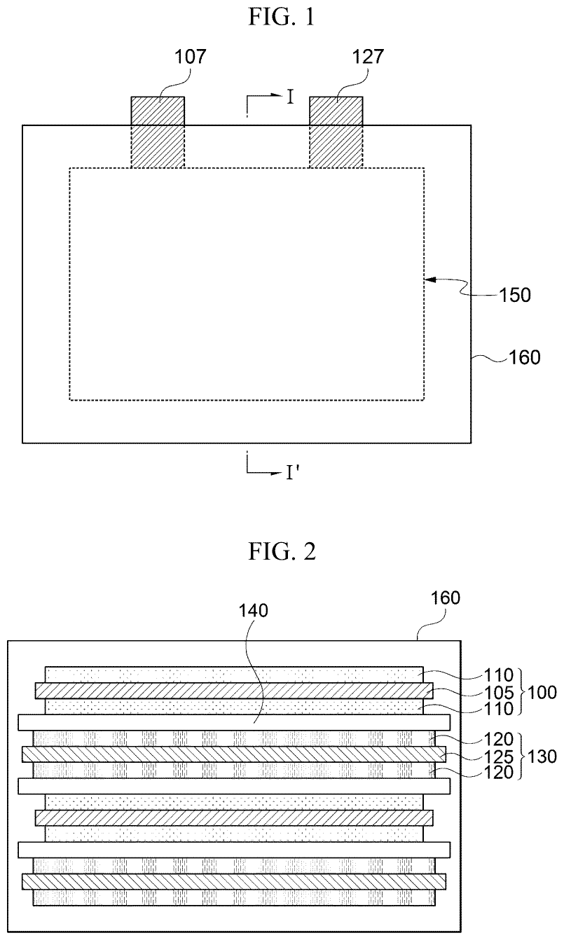

The detailed structure of the lithium secondary battery will be described below with reference to FIGS. 1 and 2.

In exemplary embodiments, the cathode includes a cathode active material including different types of first cathode active material particles and second cathode active material particles. For example, the cathode may include a plurality of first cathode active material particles and a plurality of second cathode active material particles.

The first cathode active material particles may include lithium metal phosphate particles having an olivine structure and represented by Formula 1 below.

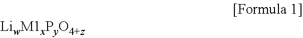

In Formula 1, w, x, y and z may satisfy 0.9≤w≤1.2, 0.99≤x≤1.01, 0.9≤y≤1.2, and −0.1≤z≤0.1, and M1 includes at least one selected from the group consisting of Fe, Co, Ni, Mn, Ti and V.

The chemical structure represented by Formula 1 indicates a bonding relationship between elements included in the crystal structure of the first cathode active material particles, and does not exclude other additional elements. For example, M1 includes Fe, Co, Ni and/or Mn, and Fe, Co, Ni and/or Mn may be provided as main active elements of the cathode active material. Here, it should be understood that Formula 1 is provided to express the bonding relationship between the main active elements, and is a formula encompassing the introduction and substitution of additional elements.

In one embodiment, the cathode active material may further include auxiliary elements which are added to the main active elements to enhance chemical stability or the crystal structure thereof. The auxiliary element may be incorporated into the crystal structure together with the main active elements to form a bond, and it should be understood that this case is also included within the chemical structure range represented by Formula 1.

The auxiliary element may include, for example, at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may also act as an auxiliary active element which contributes to the capacity/output activity of the cathode active material together with, for example, Fe, Co, Ni or Mn, such as Al.

In one embodiment, the first cathode active material particles may include LiFePO₄. By using the lithium metal phosphate particles as the first cathode active material particles, the structural and chemical stability of the lithium secondary battery may be improved and the process cost may be reduced.

According to some embodiments, the first cathode active material particles may have a carbon coating disposed on an outermost portion thereof. This may enhance electrical conductivity, thereby improving the output characteristics of the cathode active material.

According to exemplary embodiments, the cathode active material may include, together with the first cathode active material particles, second cathode active material particles represented by Formula 2 below.

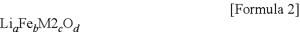

In Formula 2, a, b, c and d satisfy 4.5≤a≤5.5, 0.99≤b≤1.01, 0≤c≤1, 3.9≤d≤4.1, and M2 includes at least one selected from the group consisting of Mn, Ti and V.

In a comparative example, the ratio of the discharge capacity to the charge capacity of the first cathode active material particles (hereinafter, also abbreviated as “¹ charge-discharge efficiency”) may be higher than that of the anode active material (e.g., SiOₓ (0<x<2)). In this case, the irreversible capacity may increase, thereby decreasing the energy density of the lithium secondary battery.

In a comparative example, the charge-discharge efficiency of the anode active material (e.g., SiOₓ) may be 90% or less, and the charge-discharge efficiency of the lithium metal phosphate (e.g., LiFePO₄) may be 96% or more. Accordingly, some of the lithium ions that migrate to the anode active material during charging may not migrate back to the cathode due to the relatively low charge-discharge efficiency of the anode active material and may remain within the anode active material. Consequently, the lithium ions remaining in the anode active material may not contribute to capacity as irreversible lithium, resulting in a decrease in the available capacity and a reduction in the energy density of the lithium secondary battery.

According to exemplary embodiments, the charge-discharge efficiencies of the cathode active material and the anode active material may be substantially similar. Accordingly, during charging, an amount of lithium ions corresponding to the charge-discharge efficiency of the cathode (e.g., 96% or more) among the lithium ions migrated to the anode active material may migrate to the cathode active material. Consequently, the energy density and capacity expression characteristics of the lithium secondary battery may be improved.

The second cathode active material particles according to exemplary embodiments may, for example, have lower charge-discharge efficiency than the first cathode active material particles. Accordingly, the charge-discharge efficiency of the entire cathode active material may be controlled to be similar to that of the anode active material, which has a relatively low charge-discharge efficiency. Consequently, the irreversible capacity of the lithium secondary battery may be reduced, thereby improving the energy density.

The chemical structure represented by Formula 2 indicates a bonding relationship between elements included in the layered structure or crystal structure of the second cathode active material particles and does not exclude other additional elements. For example, the second cathode active material particles may further include the above-described auxiliary elements in the layered structure or crystal structure.

In one embodiment, the second cathode active material particles may include Li₅FeO₄.

In some embodiments, the content of the second cathode active material particles, based on the total weight of the cathode active material, may be 5% by weight (“wt %”) to 12 wt %. Within this range, the energy density may be sufficiently improved while preventing excessive degradation of the charge-discharge efficiency of the entire cathode active material.

In some embodiments, the average composition of the entire cathode active material, including the first cathode active material particles and the second cathode active material particles, may be represented by Formula 3 below.

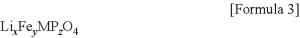

In Formula 3, x, y and z satisfy 1.02≤x≤1.56, 0.99≤y≤1.01, and 0.86≤z≤0.995, and M includes at least one selected from the group consisting of Mn, Ti and V.

For example, as the content of the second cathode active material particles in the cathode active material increases, x may increase and z may decrease.

In exemplary embodiments, the anode includes an anode active material including a silicon-based active material. The capacity characteristics of the anode active material may be enhanced through the silicon-based active material. For example, the silicon-based active material may include a plurality of silicon-based active material particles.

For example, the silicon-based active material particles may include at least one selected from the group consisting of Si, SiOₓ (0<x<2), a Si-Q alloy (where Q is an element selected from the group consisting of alkali metals, alkaline earth metals, Group 13 elements, Group 14 elements, Group 15 elements, Group 16 elements, transition metals, rare earth elements, and a combination thereof, but is not Si), and Si-carbon composites. For example, the silicon-based active material particles may include a mixture of at least one selected from the above-described group and SiO₂. In some embodiments, the silicon-based active material particles may include Si or SiOₓ (0<x<2), and according to an embodiment, may include SiOₓ (0<x<2).

According to an embodiment, the silicon-based active material particles may include SiO.

For example, while silicon-based active materials provide high capacity, their charge-discharge efficiency may be lower than that of the first cathode active material particles. Therefore, when the first cathode active material particles (or lithium metal phosphate particles) are used as the cathode active material and the silicon-based active material is used as the anode active material, the irreversible capacity of the lithium secondary battery may increase, thereby reducing energy density.

However, the cathode active material may include the first cathode active material particles and the second cathode active material particles having lower charge-discharge efficiency than the silicon-based active material, thereby preventing a decrease in energy density.

In some embodiments, the silicon-based active material particles may have a carbon coating disposed on an outermost portion thereof. This may prevent the silicon-based active material particles from contacting atmospheric moisture and/or water in the anode slurry. Consequently, the capacity characteristics of the lithium secondary battery may be improved.

For example, the carbon coating may include at least one selected from the group consisting of amorphous carbon, carbon nanotubes, carbon nanofibers, graphite, graphene, graphene oxide, and reduced graphene oxide.

According to some embodiments, the anode active material may further include a graphite-based active material. The graphite-based active material may include a plurality of graphite-based active material particles.

For example, the graphite-based active material may include at least one selected from the group consisting of artificial graphite and natural graphite.

By using the silicon-based active material and the graphite-based active material together, the high-capacity characteristics of silicon may be achieved while improving cycle life characteristics.

For example, the silicon-based active material may increase the capacity per unit weight of the anode. Accordingly, the weight of the anode active material required to achieve the same capacity may be reduced, while the weight of the cathode active material may be increased. Therefore, the silicon-based active material may increase the energy density of the lithium secondary battery.

For example, the anode active material may include a plurality of silicon-based active material particles and a plurality of graphite-based active material particles.

For example, the content of the silicon-based active material particles, based on the total weight of the anode active material (e.g., the total weight of the plurality of silicon-based active material particles and the plurality of graphite-based active material particles) may be 1 wt % or more, 3 wt % or more, 5 wt % or more, 10 wt % or more, 15 wt % or more, 20 wt % or more, 25 wt % or more, 30 wt % or more, 35 wt % or more, 40 wt % or more, or 45 wt % or more.

The content of the silicon-based active material particles, based on the total weight of the anode active material, may be 99 wt % or less, 97 wt % or less, 95 wt % or less, 90 wt % or less, 85 wt % or less, 80 wt % or less, 75 wt % or less, 70 wt % or less, 65 wt % or less, 60 wt % or less, 55 wt % or less, or 50 wt % or less.

In one embodiment, the anode active material may be substantially composed of the silicon-based active material particles and the graphite-based active material particles.

According to some embodiments, the content of the silicon-based active material, based on the total weight of the anode active material, may be 5 wt % to 20 wt %. Within this range, the capacity characteristics and energy density of the lithium secondary battery may be improved, and the cycle life characteristics may be maintained and/or enhanced.

FIGS. 1 and 2 are schematic plan and cross-sectional views, respectively, illustrating a lithium secondary battery according to exemplary embodiments. For example, FIG. 2 is a cross-sectional view taken along line I-I′ of FIG. 1 in the thickness direction of the lithium secondary battery.

Referring to FIGS. 1 and 2, the lithium secondary battery may include a cathode 100 including the above-described cathode active material, and an anode 130 disposed to face the cathode 100 and including the above-described anode active material.

The cathode 100 may include a cathode current collector 105, and a cathode active material layer 110 disposed on at least one surface of the cathode current collector 105.

The cathode current collector 105 may include stainless steel, nickel, aluminum, titanium, or an alloy thereof. The cathode current collector 105 may also include aluminum or stainless steel having a surface treated with carbon, nickel, titanium or silver. For example, the cathode current collector 105 may have a thickness of 10 μm to 50 μm.

The cathode active material layer 110 may include a cathode active material including the above-described first and second cathode active material particles.

The cathode active material may be mixed in a solvent to prepare a cathode slurry. The cathode slurry may be coated on at least one surface of the cathode current collector 105, and then dried and roll-pressed to prepare the cathode active material layer 110. The coating may include a method such as gravure coating, slot die coating, simultaneous multilayer die coating, imprinting, doctor blade coating, dip coating, bar coating or casting. The cathode active material layer 110 may further include a binder, and optionally may further include a conductive material, a thickener or the like.

As the solvent, N-methyl-2-pyrrolidone (NMP), dimethylformamide, dimethylacetamide, N,N-dimethylaminopropylamine, ethylene oxide, tetrahydrofuran, and the like may be used.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR) and the like. These may be used alone or in combination of two or more thereof.

In one embodiment, a PVDF-based binder may be used as the cathode binder. In this case, the amount of binder for forming the cathode active material layer 110 may be decreased and the amount of the cathode active material may be relatively increased. Accordingly, the output characteristics and capacity characteristics of the secondary battery may be improved.

The conductive material may be added to the cathode active material layer 110 in order to enhance the conductivity thereof and/or the mobility of lithium ions or electrons. For example, the conductive material may include carbon-based conductive materials such as graphite, carbon black, acetylene black, Ketjen black, graphene, carbon nanotubes (CNTs), vapor-grown carbon fibers (VGCFs) or carbon fibers, and/or metal-based conductive materials, including perovskite materials, such as tin, tin oxide, titanium oxide, LaSrCoO₃, and LaSrMnO₃. These may be used alone or in combination of two or more thereof.

For example, the thickener may include carboxymethyl cellulose (CMC).

The anode 130 may include an anode current collector 125 and an anode active material layer 120 disposed on at least one surface of the anode current collector 125.

For example, the anode current collector 125 may include a copper foil, a nickel foil, a stainless steel foil, a titanium foil, a nickel foam, a copper foam, a polymer substrate coated with conductive metal and the like. These may be used alone or in combination of two or more thereof. For example, the anode current collector 125 may have a thickness of 10 μm to 50 μm.

The anode active material layer 120 may include an anode active material including the above-described silicon-based active material.

The anode active material may be mixed in a solvent to prepare an anode slurry. The anode slurry may be coated or deposited on the anode current collector 125, and then dried and roll-pressed to prepare the anode active material layer 120. The coating may include processes such as gravure coating, slot die coating, simultaneous multilayer die coating, imprinting, doctor blade coating, dip coating, bar coating or casting, etc. The anode active material layer 120 may further include a binder, and optionally may further include a conductive material, a thickener or the like.

The solvent included in the anode slurry may include water, pure water, deionized water, distilled water, ethanol, isopropanol, methanol, acetone, n-propanol, t-butanol and the like. These may be used alone or in combination of two or more thereof.

The above-described materials that can be used when preparing the cathode 100 as the binder, conductive material and thickener may also be used for the anode.

In some embodiments, a styrene-butadiene rubber (SBR)-based binder, carboxymethyl cellulose (CMC), polyacrylic acid-based binder, poly(3,4-ethylenedioxythiophene) (PEDOT)-based binder, and the like may be used as an anode binder. These may be used alone or in combination of two or more thereof.

In exemplary embodiments, a separation membrane 140 may be interposed between the cathode 100 and the anode 130. The separation membrane 140 may be configured to prevent an electrical short-circuit between the cathode 100 and the anode 130, and to allow the flow of ions. For example, the separation membrane may have a thickness of 10 μm to 20 μm.

For example, the separation membrane 140 may include a porous polymer film or a porous nonwoven fabric.

The porous polymer film may include a polyolefin-based polymer such as an ethylene polymer, a propylene polymer, an ethylene/butene copolymer, an ethylene/hexene copolymer, and an ethylene/methacrylate copolymer, etc. These may be used alone or in combination of two or more thereof.

The porous nonwoven fabric may include glass fibers having a high melting point, polyethylene terephthalate fibers, etc.

The separation membrane 140 may also include a ceramic-based material. For example, inorganic particles may be coated on the polymer film or dispersed within the polymer film to improve heat resistance.

The separation membrane 140 may have a single-layer or multi-layer structure including the above-described polymer film and/or non-woven fabric.

According to exemplary embodiments, an electrode cell may be defined by the cathode 100, the anode 130 and the separation membrane 140, and a plurality of electrode cells may be stacked to form, for example, a jelly roll type electrode assembly 150. For example, the electrode assembly 150 may be formed by winding, stacking, z-folding, or stack-folding the separation membrane 140.

The electrode assembly 150 may be accommodated in a case 160 together with the electrolyte to define a lithium secondary battery. According to exemplary embodiments, a non-aqueous electrolyte may be used as the electrolyte.

The non-aqueous electrolyte may include a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), butylene carbonate, diethyl carbonate (DEC), dimethyl carbonate (DMC), ethyl methyl carbonate (EMC), methyl propyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxyethane, sulfolane, gamma-butyrolactone, propylene sulfite, and the like may be used. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), etc.

The fluorine-substituted carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis(oxalato) phosphate, lithium difluoro phosphate, etc.

The borate compound may include lithium bis(oxalate) borate, etc.

In some embodiments, a solid electrolyte may be used in place of the above-described non-aqueous electrolyte. In this case, the lithium secondary battery may be manufactured in the form of an all-solid-state battery. In addition, a solid electrolyte layer may be disposed between the cathode 100 and the anode 130 in place of the above-described separation membrane 140.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li2O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂—LiₚMO_{q} (p and q are positive numbers, M is P, Si, Ge, B, Al, Ga or In), Li₇-xPS₆-xClₓ (0≤x≤2), Li₇-xPS₆-xBrₓ (0≤x≤2), Li₇-xPS₆-xIₓ (0≤x≤2), etc. These may be used alone or in combination of two or more thereof.

In one embodiment, the solid electrolyte may include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

As shown in FIGS. 1 and 2, electrode tabs (cathode tabs and anode tabs) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) that extend or are exposed to the outside of the case 160.

The lithium secondary battery may be manufactured, for example, in a cylindrical shape using a can, a prismatic shape, a pouch shape or a coin shape.

Hereinafter, embodiments of the present disclosure will be further described with reference to specific experimental examples. However, the examples and comparative examples included in the experimental examples are provided merely for illustrative purposes of the present disclosure and are not intended to limit the scope of the appended claims. It will be apparent to those skilled in the art that various changes and modifications can be made within the scope and spirit of the present disclosure, and such changes and modifications are to be regarded as falling within the scope of the appended claims.

### Example 1

### Preparation of Cathode Active Material

Lithium carbonate as a lithium source, iron phosphate, and glucose as a carbon coating source were added to distilled water. The particles were mixed and pulverized using a ball mill to form a mixed solution containing LiFePO₄.

The resulting LiFePO₄ mixed solution was dried using a spray dryer equipped with a micro-nozzle.

The dried powder was calcined at about 300° C. to 1000° C. for about 3 to 10 hours in a nitrogen atmosphere, followed by classification and de-ironing processes to prepare lithium metal phosphate particles as the first cathode active material particles.

A mixture was prepared by mixing Fe₂O₃ particles with a median particle diameter of several tens to several hundreds of nanometers and lithium hydroxide in a stoichiometric amount. This mixture was calcined at about 600° C. to 1000° C. for 72 hours in a nitrogen atmosphere to prepare Li₅FeO₄ particles as the second cathode active material particles.

The Li₅FeO₄ slowly decomposes when exposed to moist air, so its exposure time was minimized and it was stored in an inert atmosphere.

The cathode active material was prepared by mixing the first cathode active material particles and second cathode active material particles prepared as described above so that the content of the second cathode active material particles accounted for 6 wt % based on the total weight of the first and second cathode active material particles.

### Preparation of Anode Active Material

Silicon and SiO₂ were mixed in a 1:1 weight ratio to form a mixture.

The mixture was calcined at a temperature of 1,500° C. and then cooled to precipitate a silicon oxide composite. The precipitated silicon oxide composite was pulverized and classified to prepare SiO as a silicon-based active material.

The prepared silicon-based active material and artificial graphite were mixed so that the content of the silicon-based active material accounted for 5 wt % based on the total weight of the silicon-based active material and artificial graphite, thereby preparing the anode active material.

### Manufacture of Lithium Secondary Battery

A lithium secondary battery was manufactured using the cathode active material and anode active material.

Specifically, the cathode active material, Denka Black as a conductive material, and polyvinylidene fluoride (PVDF) as a binder were mixed in a mass ratio of 93:5:2 to prepare a cathode slurry. The cathode slurry was coated onto an aluminum current collector, and then dried and roll-pressed to fabricate a cathode.

Water was added to 95.5 wt % of the anode active material, 0.50 wt % of an SWCNT conductive material, and 4.00 wt % of CMC/SBR (binder, 1.50/2.50 wt %) to prepare the anode active material composition in the form of slurry. The prepared anode active material composition was coated onto one surface of a copper current collector (a copper foil having a thickness of 8 μm), and then dried and roll-pressed to fabricate an anode including an anode active material layer.

The cathode and anode fabricated as described above were each notched into circular shapes having diameters of Φ14 and Φ16, respectively, and laminated with a separation membrane (polyethylene, thickness: 13 μm) notched into Φ19 interposed between the cathode and the anode to form an electrode cell. ΦN (N is a positive number) may denote a circular shape having a diameter of N mm.

The electrode cell was placed in a coin cell outer case of standard (CR2032) having a diameter of 20 μmm and a height of 3.2 μmm, followed by electrolyte injection and assembly. Thereafter, aging was carried out for 12 hours or more to allow the electrolyte to be impregnated into the electrode.

A 1M LiPF₆ solution prepared using a mixed solvent of EC/EMC (30/70; volume ratio) was used as the electrolyte.

Formation charging and discharging were performed on the secondary battery manufactured as described above (charging conditions: CC-CV 0.1 C 4.3V 0.005 C cut-off, discharging conditions: CC 0.1 C 3V cut-off).

### Examples 2 to 7 and Comparative Examples 1 to 4

Cathode active materials, anode active materials, and lithium secondary batteries were manufactured in the same manner as in Example 1, except that the content of the silicon-based active material, based on the total weight of the anode active material, and the content of second cathode active material particles, based on the total weight of the cathode active material, were adjusted as shown in Table 1.

### Experimental Example

### (1) Evaluation of Relative Energy Density

The discharge capacity of the lithium secondary batteries manufactured according to the above-described examples and comparative examples was measured under a current condition of 0.33 C. The measured discharge capacity was converted into energy density (Wh/kg) under conditions of the same area and the same volume.

The energy density was then divided by the energy density of the lithium secondary battery manufactured according to Comparative Example 1, and expressed as a percentage.

The calculation results were evaluated as the relative energy density (%).

### (2) Evaluation of Capacity Retention

The lithium secondary batteries manufactured according to the above-described examples and comparative examples were subjected to 50 cycles of charging (CC/CV 1/3 C 4.2V 0.05 C cut-off) and discharging (CC 1/3 C 2.5V cut-off) in a chamber maintained at 25° C.

The discharge capacity at the 50th cycle was divided by the discharge capacity at the first cycle, and the percentage was calculated. The calculation results were evaluated as the capacity retention rate (%).

The evaluation results are shown in Table 1 below.

TABLE 1

| | Content of | Content of | | Capacity |
|---|---|---|---|---|
| | second cathode | silicon- | Relative | retention |
| | active material | based active | energy | rate (50 |
| | particles | material | density | cycles) |
| Classification | (wt %) | (wt %) | (%) | (%) |
| Example 1 | 6 | 5 | 106.0 | 94.5 |
| Example 2 | 8 | 10 | 109.0 | 92.8 |
| Example 3 | 12 | 20 | 114.4 | 89.7 |
| Example 4 | 4 | 10 | 105.2 | 92.4 |
| Example 5 | 14 | 10 | 106.2 | 92.3 |
| Example 6 | 6 | 3 | 105.1 | 95.6 |
| Example 7 | 6 | 22 | 107.2 | 87.2 |
| Comparative | 0 | 0 | 100 | 96.5 |
| Example 1 | | | | |
| Comparative | 0 | 5 | 101.5 | 94.4 |
| Example 2 | | | | |
| Comparative | 0 | 10 | 102.7 | 92.1 |
| Example 3 | | | | |
| Comparative | 0 | 20 | 104.3 | 89.3 |
| Example 4 | | | | |

Referring to Table 1, the examples including the first cathode active material particles and the second cathode active material particles exhibited improved energy density compared to the comparative examples.

In Example 4, where the content of the second cathode active material particles was less than 5 wt % based on the total weight of the cathode active material, the irreversible capacity of the lithium secondary battery increased and the energy density decreased compared to Example 2, which had the same content of the silicon-based active material.

In Example 5, where the content of the second cathode active material particles was greater than 12 wt % based on the total weight of the cathode active material, the charge-discharge efficiency of the cathode active material decreased and the energy density decreased compared to Example 2, which had the same content of the silicon-based active material.

In Example 6, where the content of the silicon-based active material was less than 5 wt % based on the total weight of the anode active material, the capacity characteristics and energy density of the lithium secondary battery decreased compared to Example 1, which had the same content of the second cathode active material particles.

In Example 7, where the content of the silicon-based active material was greater than 20 wt % based on the total weight of the anode active material, the capacity retention of the lithium secondary battery decreased compared to Example 1, which had the same content of the second cathode active material particles.

1. A lithium secondary battery comprising:
a cathode comprising a cathode active material including first cathode active material particles and second cathode active material particles that are different from the first cathode active material particles and are represented by Formula 2 below; and
an anode disposed to face the cathode and comprising an anode active material including a silicon-based active material: 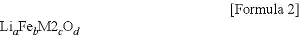
(in Formula 2, 4.5≤a≤5.5, 0.99≤b≤1.01, 0≤c≤1, 3.9≤d≤4.1, and M2 comprises at least one selected from the group consisting of Mn, Ti and V).

2. The lithium secondary battery according to claim 1, wherein the first cathode active material particles comprise lithium metal phosphate particles represented by Formula 1 below: 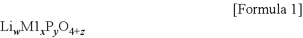
(in Formula 1, 0.9≤w≤1.2, 0.99≤x≤1.01, 0.9≤y≤1.2, −0.1≤z≤0.1, and M1 comprises at least one selected from the group consisting of Fe, Co, Ni, Mn, Ti and V).

3. The lithium secondary battery according to claim 1, wherein the first cathode active material particles comprise LiFePO₄.

4. The lithium secondary battery according to claim 1, wherein the second cathode active material particles comprise Li₅FeO₄.

5. The lithium secondary battery according to claim 1, wherein the content of the second cathode active material particles, based on the total weight of the cathode active material, is 5% by weight to 12% by weight.

6. The lithium secondary battery according to claim 1, wherein the silicon-based active material comprises SiOₓ (0<x<2).

7. The lithium secondary battery according to claim 1, wherein the anode active material further comprises a graphite-based active material.

8. The lithium secondary battery according to claim 7, wherein the graphite-based active material comprises at least one selected from the group consisting of artificial graphite and natural graphite.

9. The lithium secondary battery according to claim 1, wherein the content of the silicon-based active material, based on the total weight of the anode active material, is 5% by weight to 20% by weight.

10. The lithium secondary battery according to claim 1, wherein the silicon-based active material comprises a carbon coating disposed on an outermost portion thereof.

11. The lithium secondary battery according to claim 1, wherein an average composition of the entire cathode active material is expressed by Formula 3 below: 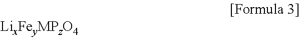
(in Formula 3, 1.02≤x≤1.56, 0.99≤y≤1.01, 0.86≤z≤0.995, and M comprises at least one selected from the group consisting of Mn, Ti and V).

12. The lithium secondary battery according to claim 1, wherein the first cathode active material particles and the second cathode active material particles each further comprise an auxiliary element included in a layered structure, and
wherein the auxiliary element comprises at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra and P.
